(19) United States
(12) Patent Application Publication
(10) Pub. No.: US 2003/0067439 A1
(43) Pub. Date: Apr. 10, 2003

(54) Digital clipboard

(76) Inventor: Hans A. Lichtfuss, Loveland, CO (US)

Correspondence Address: HEWLETT-PACKARD COMPANY, Intellectual Property Administration, P.O. Box 272400, Fort Collins, CO, 80527-2400, US

(21) Appl. No.: 09/974,411

(22) Filed: Oct. 9, 2001

(51) Int. Cl. G09G 5/00

(52) U.S. Cl. 345/156

(57) ABSTRACT

A form management device has a base unit and a detachable clipboard. Within the base unit is an imaging system and a network communication interface. Providing communication between the base unit and the clipboard are a pair of mating communication interfaces, one in the base unit and the other in the detachable clipboard. The clipboard has a display where documents are viewed, fields are inserted into documents, and data is input to the fields. The documents and field data are stored on an information storage device.

### FIELD OF THE INVENTION

This invention relates in general to document management and, more particularly, to electronic form creation from hardcopy documents.

### BACKGROUND OF THE INVENTION

Forms are pervasive in today's society. They are extensively used in a wide variety of situations. Typically, forms are printed or typed documents with blank spaces for insertion of information. These printed or typed forms are convenient to carry and allow for quick data recordation. These forms are frequently carried and completed on a clipboard.

Once completed, the information provided on a form is often transcribed to a different form of record. Usually, the information provided on the form is transcribed to a computer record. Transcription from a form to a computer is time consuming, especially when many forms are to be transcribed.

As a result, a recent trend involves providing the form as an electronic form on a computer. Data is input directly to the computer without the need to further transcribe the data. These electronic forms are usually very convenient. However, many times it is desirable to carry a form and record information on the form while being away from a desktop computer. It is also often desirable to quickly create an electronic form from a hardcopy document.

### SUMMARY OF THE INVENTION

According to principles of the present invention, a form management device has a base unit and a detachable clipboard. Within the base unit is an imaging system. Providing communication between the base unit and the clipboard are a pair of mating communication interfaces, one in the base unit and the other in the detachable clipboard. The clipboard has a display where documents are viewed, fields are inserted into documents, and data is input to the fields. The documents and field data are stored on an information storage device within the detachable clipboard.

According to further principles of the present invention, a processing system controls the imaging system, the display, the field inserter, and the information storage device.

### DESCRIPTION OF THE DRAWINGS

FIG. 1 is a diagrammatical illustration representing one embodiment of the form management device of the present invention.

FIG. 2 is a block diagram representing one embodiment of the form management device of the present invention.

FIG. 3 is a diagrammatical illustration representing one embodiment of the detachable clipboard of FIGS. 1 and 2.

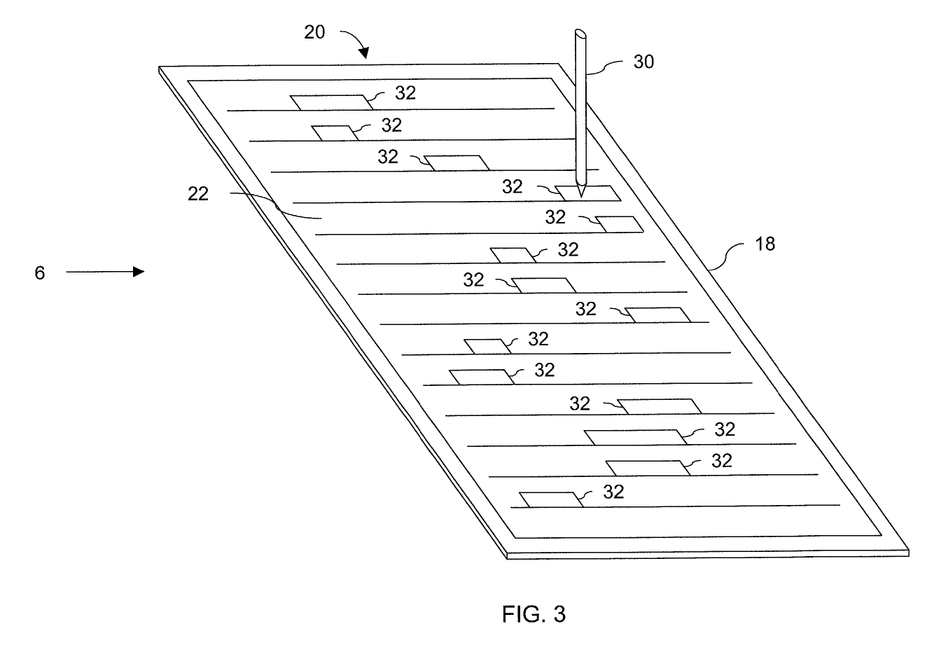

### DETAILED DESCRIPTION OF THE INVENTION

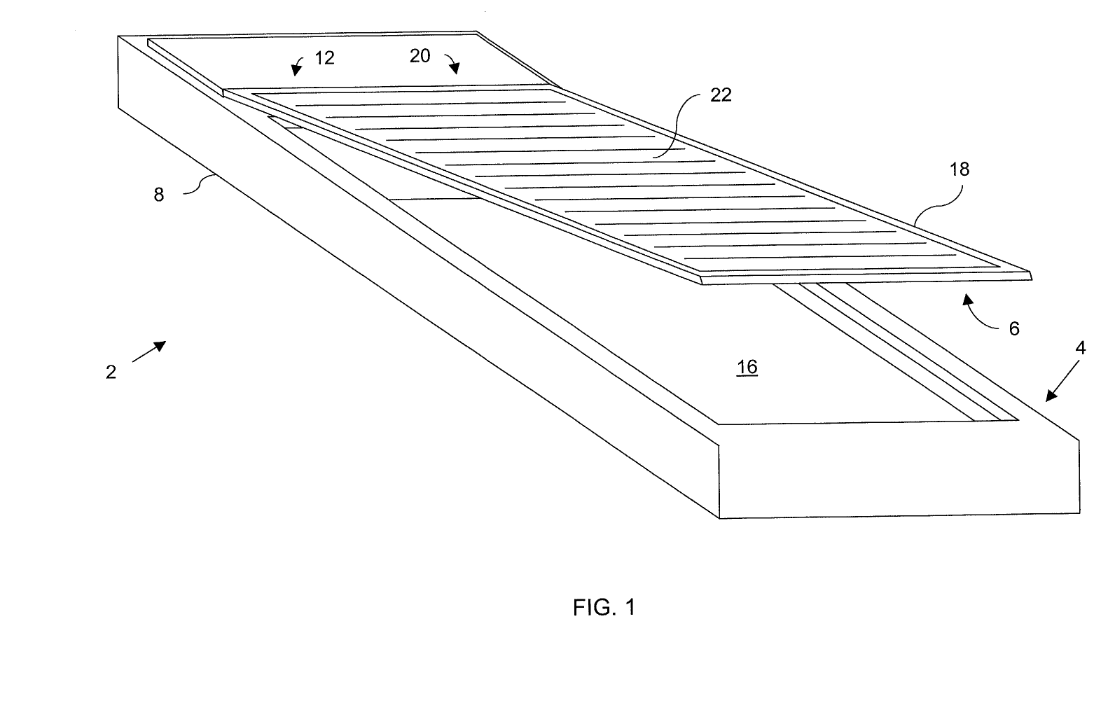

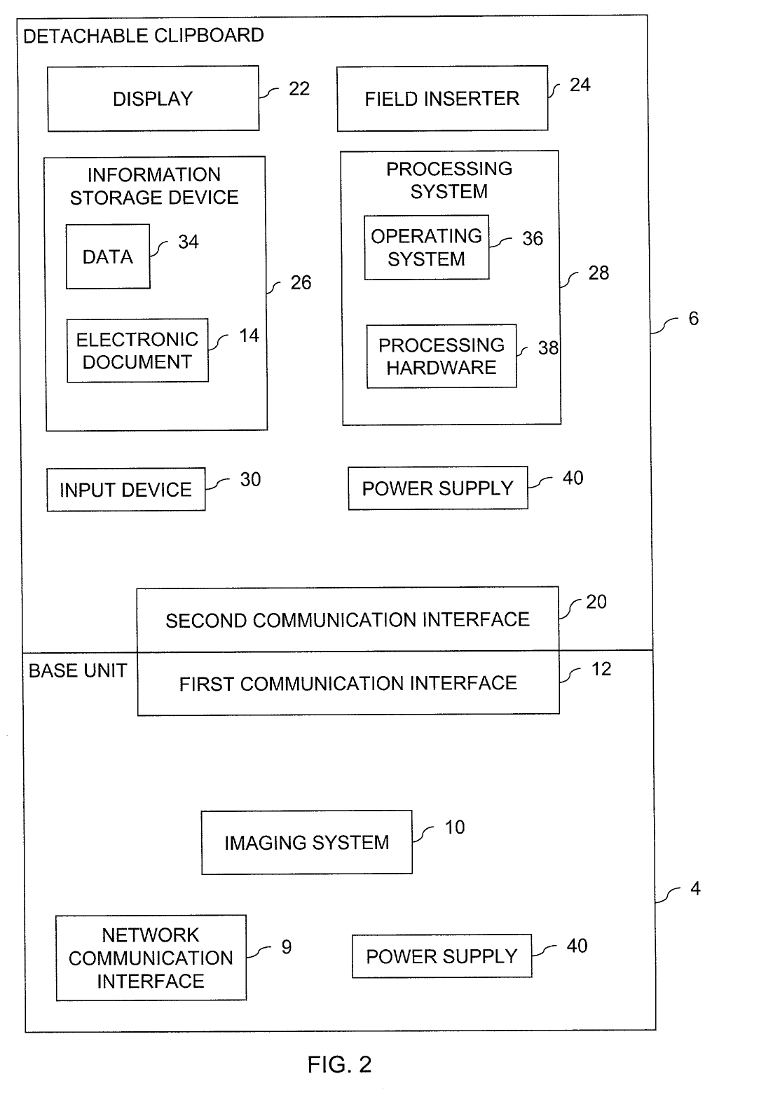

Illustrated in FIGS. 1 and 2 is one embodiment of a form manager 2 of the present invention. Form manager 2 includes a base unit 4 and a detachable clipboard unit 6. Base unit 4 includes a first housing 8 and an imaging system 10.

First housing 8 is any housing suited for use as a housing for base unit 4. First housing 6 includes a first communication interface 12 configured to provide communication with detachable clipboard 6. In one embodiment, first housing 8 further includes a network communication interface 9 configured to provide network communication to base unit 4. Network communication interface 9 is of a type suited to the type of network communicating with base unit 4. The network may be any type of network, such as an intranet or the Internet. The network communication allows form manager 2 to send and receive electronic documents 14 and form data 34.

Imaging system 10 is any combination of hardware and executable code capable of creating an electronic document 14 from a hardcopy document 16 and communicating electronic document 14 to first communication interface 12. In one embodiment, imaging system 10 includes an optical imager (not shown) configured to generate analog sensor data from hardcopy document 16 and processing system 28 includes a processor (not shown) configured to process the analog sensor data to generate electronic document 14.

Detachable clipboard 6 includes a second housing 18 having a second communication interface 20, a display 22, a field inserter 24, an information storage device 26, and a processing system 28. Either included in detachable clipboard 6 or separate from detachable clipboard 6 is an input device 30.

Second housing 18 is any housing suited for use as a housing for detachable clipboard 6. Second communication interface 20 mates with first communication interface 12 to provide communication between base unit 4 and detachable clipboard 6. First communication interface 12 and second communication interface 20 are depicted at one end of second housing 18. Alternatively, first communication interface 12 and second communication interface 20 are positioned at other mating positions in first housing 8 and second housing 18, respectively.

Display 22 is mounted to or within second housing 18. Display 22 is any display capable of displaying electronic document 14. For example, display 22 may include a flexible substrate display or a liquid crystal display (LCD).

Field inserter 24 is any combination of hardware and executable code configured to insert form fields 32 into electronic document 14. Form fields 32 are data fields configured to receive data 34. Field inserter 24 resides within second housing 18. In one embodiment, field inserter 24 is a computer application.

Field inserter 24 inserts form fields 32 into electronic document 14 by identifying field locations within electronic document 14 and establishing form fields 32 at those locations. In one embodiment, the field locations are identified by receiving location information from input device 30. In another embodiment, field inserter 24 identifies the field locations from the content of electronic document 14. For example, key shapes or symbols in electronic document 14 may indicate a desired field location. The location of the key shapes or symbols within electronic document are identified by field inserter 24 as field location. Once inserted, form fields 32 may be saved with electronic document 14.

Information storage device 26 is any device for storing electronic document 14 and data 34. Examples of information storage device 26 include a magnetic storage device, an electronic storage device, and an optical storage device.

Processing system 28 is any combination of hardware and executable code, responsive to input device 30, configured to control display 22, field inserter 24, information storage device 26, and processing system 28. In one embodiment, processing system 28 further controls imaging system 10. In one embodiment, processing system 28 includes an operating system 36 and processing hardware 38.

Input device 30 is any combination of hardware and software capable of allowing a user to provide input to form manager 2. For example, input device 30 may include a touch sensitive display, an analog input device, an electronic stylus, or a keyboard. Input device 30 is useful for conveying location information to field inserter 24, entering data 34 into form fields 32, and providing input to processing system 28.

In one embodiment, form management device 2 further includes at least one power supply 40 configured to supply power to imaging system 10, display 22, field inserter 24, input device 30, information storage device 26, and processing system 28. In one embodiment, power supply 40 includes a portable power supply, configured to provide power to detachable clipboard unit 6.

The foregoing description is only illustrative of the invention. Various alternatives and modifications can be devised by those skilled in the art without departing from the invention. Accordingly, the present invention embraces all such alternatives, modifications, and variances that fall within the scope of the appended claims.

What is claimed is:

1. A form management device comprising:
(a) a first housing having a first communication interface;
(b) an imaging system, within the first housing, configured to create an electronic document from a hardcopy document, the imaging system in communication with the first communication interface;
(c) a second housing having a second communication interface, the second communication interface detachably mated, for communication, with the first communication interface;
(d) a display, mounted to the second housing, configured to display the electronic document;
(e) a field inserter, within the second housing, configured to insert form fields into the electronic document;
(f) an input device configured to enter data into the form fields;
(g) an information storage device, within the second housing, configured to store the electronic document and the entered data; and,
(h) a processing system, within the second housing, responsive to the input device, configured to control the display, the field inserter, and the information storage device, the processing system in communication with the second communication interface.

2. The form management device of claim 1 wherein the processing system further controls the imaging system.

3. The form management device of claim 2 wherein the imaging system includes an optical imager configured to generate analog sensor data from the hardcopy document and wherein the processing system includes a processor configured to process the analog sensor data to generate the electronic document.

4. The form management device of claim 1 wherein the display includes a flexible substrate.

5. The form management device of claim 1 wherein the input device is selected from the group consisting of a touch sensitive display, an analog input device, an electronic stylus, and a keyboard.

6. The form management device of claim 1 wherein the information storage device is selected from the group consisting of a magnetic storage device, an electronic storage device, and an optical storage device.

7. The form management device of claim 1 wherein the processing system includes:
(a) an operating system; and,
(b) processing hardware.

8. The form management device of claim 1 wherein the first housing further includes a network communication interface configured to provide network communication.

9. The form management device of claim 1 further including a power supply configured to supply power to the imaging system, display, field inserter, input device, information storage device, and processing system.

10. The form management device of claim 9 wherein the power supply includes a portable power supply.

11. A form management device comprising:
(a) a base unit having:
(i) a first housing having a first communication interface;
(ii) an imaging system, within the first housing, configured to create an electronic document from a hardcopy document, the imaging system in communication with the first communication interface;
(b) a detachable clipboard unit having:
(i) a second housing having a second communication interface, the second communication interface detachably mated, for communication with the first communication interface;
(ii) a display, mounted to the second housing, configured to display the electronic document;
(iii) a field inserter, within the second housing, configured to insert form fields into the electronic document;
(v) an information storage device, within the second housing, configured to store the electronic document and entered data; and,
(vi) a processing system, within the second housing, responsive to the input device, configured to control the display, the field inserter, and the information storage device, the processing system in communication with the second communication interface; and,
(c) an input device configured to enter data into the form fields.

12. The form management device of claim 11 wherein the processing system further controls the imaging system.

13. The form management device of claim 12 wherein the imaging system includes an optical imager configured to generate analog sensor data from the hardcopy document and wherein the processing system includes a processor configured to process the analog sensor data to generate the electronic document.

14. The form management device of claim 11 wherein the display includes a flexible substrate.

15. The form management device of claim 11 wherein the input device is selected from the group consisting of a touch sensitive display, an analog input device, an electronic stylus, and a keyboard.

16. The form management device of claim 11 wherein the information storage device is selected from the group consisting of a magnetic storage device, an electronic storage device, and an optical storage device.

17. The form management device of claim 11 wherein the processing system includes:
(a) an operating system; and,
(b) processing hardware.

18. The form management device of claim 1 1 wherein the first housing further includes a network communication interface configured to provide network communication.

19. The form management device of claim 11 further including a power supply configured to supply power to the imaging system, display, field inserter, input device, information storage device, and processing system.

20. The form management device of claim 19 wherein the power supply includes a portable power supply.
